(19) United States
(12) Patent Application Publication
(10) Pub. No.: US 2011/0157049 A1
(43) Pub. Date: Jun. 30, 2011

(54) APPARATUS AND METHOD FOR GENERATING VIBRATIONS IN WIRELESS TERMINAL

(75) Inventors: Ho-Jin LEE, Suwon-si (KR); Jeong-Seok Lee, Anyang-si (KR); Eun-Hwa Lee, Suwon-si (KR); Yu-Dong Bae, Suwon-si (KR); Jin-Hyoung Park, Wonju-si (KR)

(73) Assignee: Samsung Electronics Co., Ltd., Suwon-si (KR)

(21) Appl. No.: 12/976,511

(22) Filed: Dec. 22, 2010

(30) Foreign Application Priority Data
Dec. 24, 2009 (KR) 10-2009-0131257

(51) Int. Cl. G08B 6/00; G06F 3/041

(52) U.S. Cl. 345/173

(57) ABSTRACT

Provided is an apparatus and method for generating vibrations in a wireless terminal, in which vibrations of strengths corresponding to respective regions are generated by using a plurality of piezos. The apparatus includes a plurality of piezos, a touch screen portion including a plurality of regions, and a controller for, upon detection of a touch on a predetermined region among the plurality of regions of the touch screen portion, generating vibrations of strengths according to power frequencies and power polarities of the plurality of piezos with respect to the touched region.

### PRIORITY

This application claims priority under 35 U.S.C. §119(a) to Korean Patent Application Serial No. 10-2009-131257 filed in the Korean Intellectual Property Office on Dec. 24, 2009, the entire disclosure of which is incorporated herein by reference.

### BACKGROUND OF THE INVENTION

1. Field of the Invention

The present invention generally relates to an apparatus and method for generating vibrations in a wireless terminal and, more particularly, to an apparatus and method for generating vibrations in a wireless terminal, in which vibrations of varying strengths corresponding to respective regions are generated by using a plurality of piezos.

2. Description of the Related Art

Conventional wireless terminals provide a haptic effect by changing a number of pulses or amplitude of pulses provided to a piezo, which is a type of vibrator.

For a vibrator such as a motor, an active braking scheme has been used to suppress rotation caused by inertia.

Conventional methods for changing the number or amplitude of the pulses typically controls duration and strength of vibration, but is ineffective for control of a vibrator having a high response speed, such as a piezo.

Moreover, for a piezo, a waveform is reversed when a power polarity is changed. Conventional methods fail to sufficiently utilize advantageous features of the piezo.

### SUMMARY OF THE INVENTION

Accordingly, an aspect of the present invention provides an apparatus and method for generating vibrations in a wireless terminal, in which strengths of vibrations generated in corresponding respective regions are generated using a plurality of piezos.

Another aspect of the present invention provides an apparatus and method for generating vibrations in a wireless terminal, in which vibration strengths correspond to respective regions and a visual User Interface (UI) is provided to maximize a haptic effect.

According to an aspect of the present invention, there is provided an apparatus for generating vibrations in a wireless terminal that includes a plurality of piezos, a touch screen portion comprising a plurality of regions, and a controller for, upon detection of a touch on a predetermined region among the plurality of regions of the touch screen portion, generating vibrations of strengths according to power frequencies and power polarities of the plurality of piezos with respect to the touched region.

According to another aspect of the present invention, there is provided a method for generating vibrations in a wireless terminal. The method includes, upon detection of a touch on a predetermined region among a plurality of regions provided on a touch screen portion, extracting a power frequency and a power polarity of each of the plurality of piezos corresponding to the touched region, and generating vibrations of strengths according to the extracted power frequency and power polarity of each of the plurality of piezos.

### BRIEF DESCRIPTION OF THE DRAWINGS

The above and other features and advantages of an embodiment of the present invention will be more apparent from the following detailed description taken in conjunction with the accompanying drawings, in which:

FIG. 1 is a block diagram of a wireless terminal according to an embodiment of the present invention;

FIG. 2 is a flowchart illustrating a process of generating vibrations of corresponding strengths upon detection of a touch on a predetermined region in a wireless terminal according to an embodiment of the present invention; and

FIGS. 3 through 5 describe strengths of vibrations generated by a plurality of piezos with respect to power frequency and power polarity according to an embodiment of the present invention.

### DETAILED DESCRIPTION OF EMBODIMENTS OF THE PRESENT INVENTION

Hereinafter, embodiments of the present invention will be described in detail with reference to the accompanying drawings. It should be noted that identical components are referred to as identical symbols throughout the drawings.

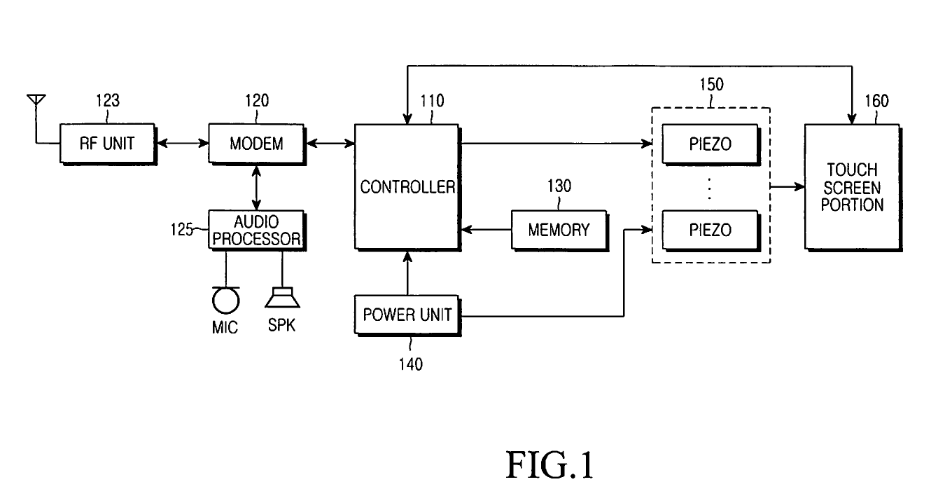

FIG. 1 is a block diagram of a wireless terminal according to an embodiment of the present invention. Referring to FIG. 1, a Radio Frequency (RF) unit 123 performs a radio communication function of the wireless terminal. The RF unit 123 includes an RF transmitter for up-converting a frequency of a transmission signal and amplifying the transmitted signal, and an RF receiver for low-noise amplifying a received signal and down-converting the frequency of the received signal. A modem 120 includes a transmitter for encoding and modulating the transmission signal, and a receiver for demodulating and decoding the received signal. An audio processor 125 is provided that includes a data codec for processing packet data and an audio codec for processing an audio signal such as voice. The audio processor 125 converts a digital audio signal received from the modem 120 into an analog signal through the audio codec and reproduces the analog signal, or converts an analog audio signal generated and transmitted from a microphone into a digital audio signal and transmits the signal to the modem 120. The codec may be separately provided or may be included in a controller 110.

A memory 130 includes program and data memories. The program memory stores programs for controlling a general operation of the wireless terminal and the data memory temporarily stores data generated during execution of the programs. The memory 130 also stores power frequency and power polarity of each of a plurality of piezos 150 with respect to each of a plurality of regions provided on a touch screen portion 160 according to an embodiment of the present invention.

For each of the plurality of piezos, which are each a vibrator, upon application of a power having a reversed polarity, a corresponding vibration waveform is also reversed, and the vibration waveform changes with resonance based on a frequency.

In an embodiment of the present invention, a plurality of such piezos are provided.

The plurality of piezos 150 are provided on the wireless terminal, such that each of the plurality of piezos 150 generates a vibration having a strength that varies with power frequency and power polarity thereof with respect to a predetermined region, i.e. a region that is determined to be touched from among a plurality of regions provided on the touch screen portion 160.

The touch screen portion 160 displays user data output from the controller 110. The touch screen portion 160 may also serve as an input unit, which includes keys for inputting numeric and character information for various functions such as menu selection or game functions, while including the plurality of regions.

A power unit 140 supplies power to components of the wireless terminal and supplies power to each of the plurality of piezos 150.

The controller 110 controls the overall operation of the wireless terminal and may include the modem 120 and the codec.

Once it is detected that the predetermined region from among the plurality of regions provided on the touch screen portion 160 is touched, the controller 110 extracts from the memory 130 power frequency and power polarity of each of the plurality of piezos 150 corresponding to the touched predetermined region.

The controller 110 changes the frequency and polarity of power supplied from the power unit 140 to each of the plurality of the piezos 150 into the power frequency and power polarity extracted from the memory 130 for each of the plurality of piezos 150. Upon generation of a vibration waveform corresponding to the changed power frequency and power polarity of each of the plurality of piezos 150, the controller 110 increases or reduces strengths of vibrations for each of the plurality of piezos 150 of the predetermined region through superposition of increased or decreased, i.e. destructive, interference.

Once the predetermined region among the plurality of regions provided on the touch screen portion 160 is touched, the controller 110 controls the touch screen portion 160 to visually indicate generation of vibrations with respect to the touched region and detection of the touch on that region.

While the controller 110 generates vibrations of corresponding strengths upon detection of a touch on the predetermined region in the wireless terminal, such generation may be performed by a separate component.

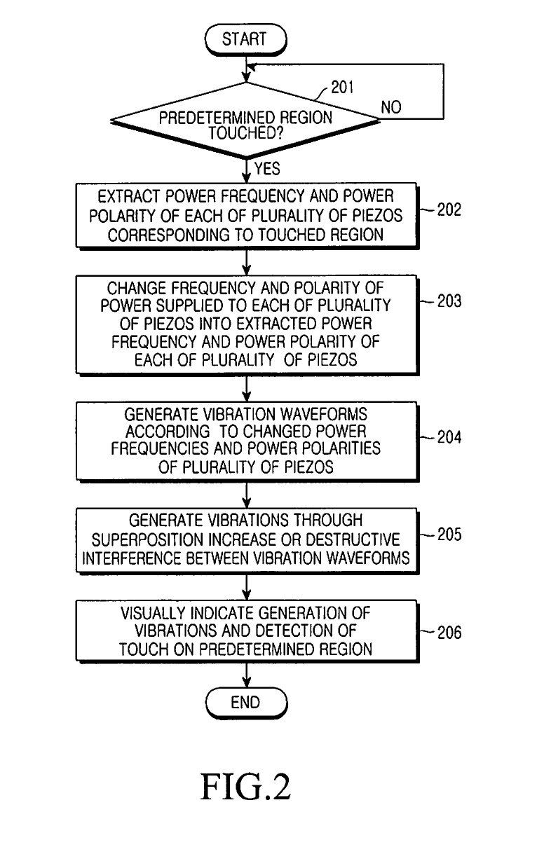

With reference to FIG. 2, a description is provided of an operation of generating vibrations of strengths corresponding to the plurality of regions provided on the touch screen portion 160 in the wireless terminal according to an embodiment of the present invention.

FIG. 2 is a flowchart illustrating a process of generating vibrations of corresponding strengths upon generation of a touch on a predetermined region in the wireless terminal according to an embodiment of the present invention.

Referring to FIG. 2, upon detection of a touch on the predetermined region among the plurality of regions of the touch screen portion 160 provided on the wireless terminal, the controller 110 senses the touch in step 201 and, in step 202, extracts power frequency and power polarity of each of the plurality of piezos 150 corresponding to the touched region from the memory 130.

Once the power frequency and power polarity of each of the plurality of piezos 150 corresponding to the touched region is extracted from the memory 130 in step 202, in step 203 the controller 110 changes the frequency and polarity of power that is supplied from the power unit 140 to each of the plurality of piezos 150 into the extracted power frequency and power polarity for each of the plurality of piezos 150.

After the power frequency and power polarity of each of the plurality of piezos 150 are changed in step 203, a vibration waveform corresponding to the changed power frequency and power polarity of each of the plurality of piezos 150 is generated in step 204.

Upon generation of the vibration waveform for each of the plurality of piezos 150 in step 204, the controller 110 increases a strength of a vibration by in-phase coupling between generated vibration waveforms, that is, by superposition of the vibration waveforms in step 205. Similarly, a reduction in strength of a vibration is provided in step 205 by out-of-phase coupling between the vibration waveforms, that is, by destructive interference between the vibration waveforms in step 205, thereby generating vibrations of strengths corresponding to the respective regions.

The controller 110 visually indicates generation of the vibrations and detection of the touch on the predetermined region in step 206.

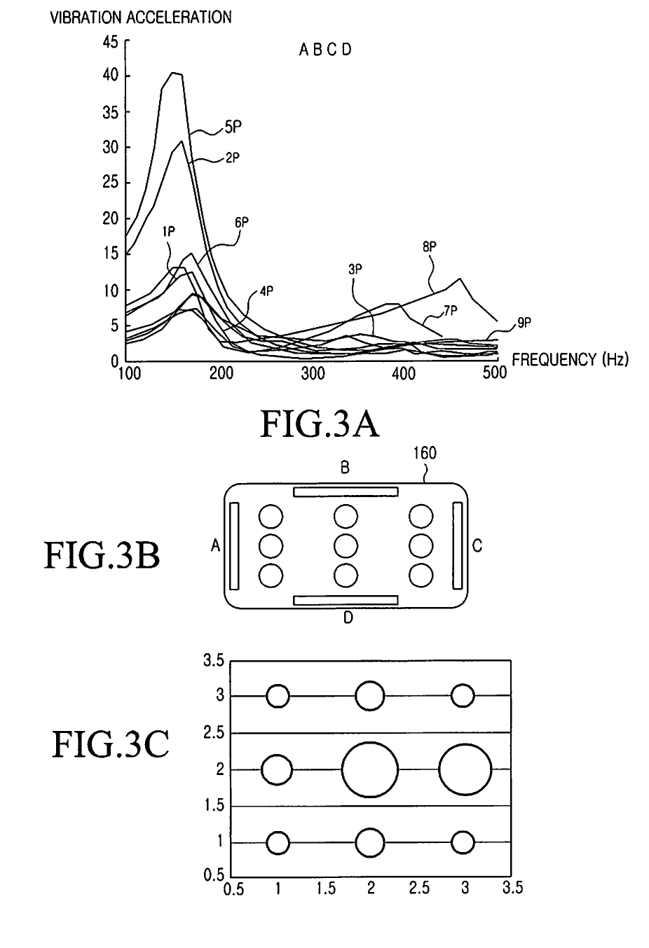

FIGS. 3A through 5 are diagrams for describing strengths of vibrations generated by a plurality of piezos with respect to power frequency and power polarity according to an embodiment of the present invention. FIGS. 3A through 3C show variations in vibration acceleration in respective regions with respect to power frequencies for the same power polarity among four piezos A through D.

FIG. 3A is a chart for a wireless terminal in which the four piezos A through D are provided and the touch screen portion 160 includes nine regions, 1P through 9P.

FIG. 3B is a graph showing variations in vibration acceleration in the nine regions 1P through 9P of the touch screen portion 160 with respect to power frequencies (Hz) for the same power polarity among the four piezos A through D in the wireless terminal of FIG. 3A.

FIG. 3C shows strengths of vibrations corresponding to the respective nine regions 1P through 9P of the touch screen portion 160 in case of the highest frequency of 150 Hz in FIG. 3B.

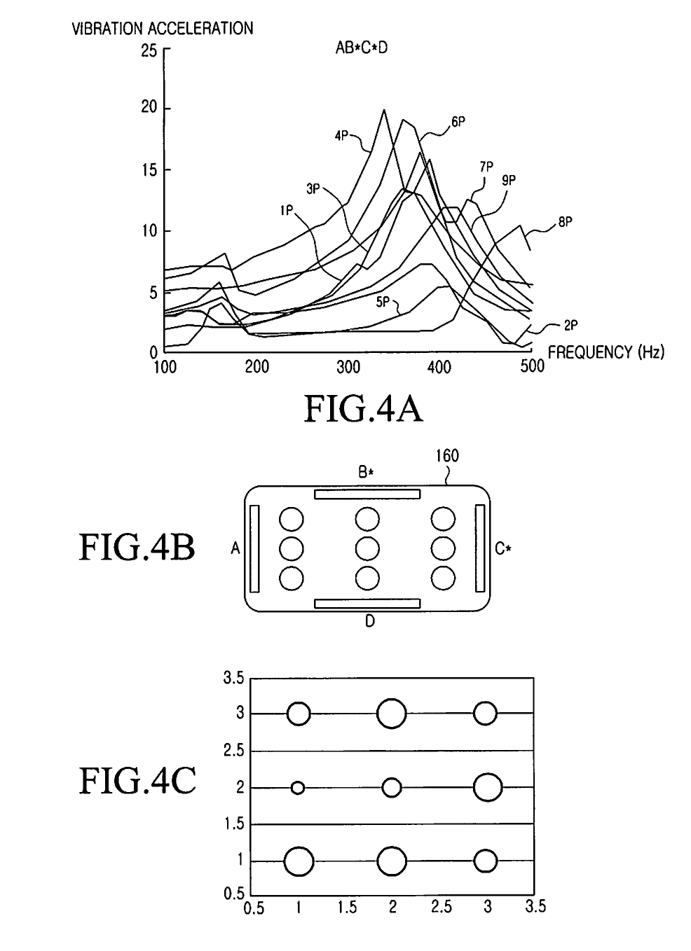

FIGS. 4A through 4C show variations in vibration acceleration in respective regions with respect to power frequencies (Hz) when power polarities of some piezos B and C of the four piezos A through D are reversed.

FIG. 4A is a chart for a wireless terminal in which the four piezos A through D are provided and the touch screen portion 160 includes nine regions, 1P through 9P.

FIG. 4B is a graph showing variations in vibration acceleration in the nine regions 1P through 9P of the touch screen portion 160 with respect to power frequencies (Hz) when some piezos A and D of the four piezos A through D have the same power polarity, and the power polarities of the piezos B* and C* are inversed in the wireless terminal shown in FIG. 4A.

FIG. 4C shows strengths of vibrations corresponding to the respective nine regions 1P through 9P of the touch screen portion 160 in case of the highest frequency of 390 Hz in FIG. 4B.

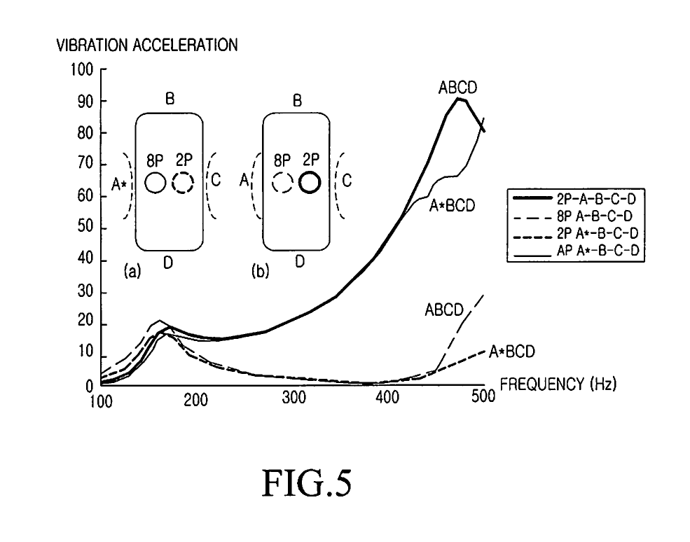

FIG. 5 shows variations in vibration acceleration in two of the nine regions, i.e. regions 2P and 8P, with respect to power polarities and power frequencies of four piezos A through D.

When the power polarities of the four piezos A through D are the same as each other, as depicted in insert (a) of FIG. 5, vibration strength corresponding to region 2P increases through superposition increase between vibration waveforms generated according to the power frequencies and the power polarities of the four piezos A through D; whereas vibration strength corresponding to region 8P decreases through destructive interference between the vibration waveforms generated according to the power frequencies and the power polarities of the four piezos A through D.

When the power polarities of three piezos B through D among the four piezos A through D are the same, and the power polarity of the piezo A is reversed as in insert (b) of FIG. 5, vibration strength corresponding to region 2P decreases through destructive interference between vibration waveforms generated according to the power frequencies and the power polarities of the four piezos A through D; whereas vibration strength corresponding to region 8P increases through superposition increase between the vibration waveforms generated according to the power frequencies and the power polarities of the four piezos A through D.

In other words, by providing the above-described apparatus and method for generating vibrations in a wireless terminal, the present invention can vary the generated strengths in corresponding respective regions by using a plurality of piezos and thereby maximize the haptic effect in combination with a visual UI.

While the present invention has been shown and described with reference to an embodiment thereof, it will be understood by those skilled in the art that various changes in form and details may be made therein without departing from the spirit and scope of the invention as defined by the appended claims. Therefore, the scope of the present invention should be defined by the appended claims and equivalents thereof, rather than the disclosed embodiment.

What is claimed is:

1. An apparatus for generating vibrations in a wireless terminal, the apparatus comprising:
a touch screen portion having a plurality of regions each having a plurality of piezos therein; and
a controller for, upon detection of a touch on a predetermined region among the plurality of regions of the touch screen portion, generating by the plurality of piezos of the predetermined touched region vibrations of strengths the vary according to power frequencies and power polarities.

2. The apparatus of claim 1, wherein, upon detection of the touch on the predetermined region among the plurality of regions, the controller extracts a power frequency and a power polarity of each of the plurality of piezos corresponding to the touched region, changes frequency and polarity of power supplied to each of the plurality of piezos into the extracted power frequency and power polarity of each of the plurality of piezos, and generates vibrations by a superposition increase or a destructive interference between vibration waveforms generated according to the changed power frequency and power polarity of each of the plurality of piezos.

3. The apparatus of claim 1, wherein the controller controls the touch screen portion to visually indicate generation of the vibrations and detection of the touch upon generation of the touch on the predetermined region.

4. The apparatus of claim 1, further comprising:
a memory for storing power frequency and power polarity of each of the plurality of piezos with respect to each of the plurality of regions; and
a power unit for supplying power to each of the plurality of piezos.

5. A method for generating vibrations in a wireless terminal, the method comprising:
upon detection of a touch on a predetermined region among a plurality of regions provided on a touch screen portion, extracting a power frequency and a power polarity for each of a plurality of piezos of the touched region; and
generating vibrations of strengths according to the extracted power frequency and power polarity of each of the plurality of piezos.

6. The method of claim 5, wherein generating the vibrations comprises:
changing frequency and polarity of power supplied to each of the plurality of piezos into the extracted power frequency and power polarity for each of the plurality of piezos; and
upon generation of vibration waveforms according to the changed power frequency and power polarity of each of the plurality of piezos, generating the vibrations with respect to detection of the touch on the predetermined region through superposition increase or destructive interference between the generated vibration waveforms.

7. The method of claim 5, further comprising visually indicating generation of the vibrations and detection of the touch upon generation of the touch on the predetermined region.

8. The method of claim 5, wherein the power frequency and power polarity of each of the plurality of piezos with respect to each of the plurality of regions are previously stored in a memory of the wireless terminal.
